(19) United States
(12) Patent Application Publication
(10) Pub. No.: US 2008/0077693 A1
(43) Pub. Date: Mar. 27, 2008

(54) SYSTEM AND METHOD FOR AUTOMATICALLY GENERATING A PROXY INTERFACE OBJECT TO COMMUNICATE THROUGH A GATEWAY SOFTWARE SERVER TO A REMOTE SOFTWARE SERVER

(75) Inventors: Imad G. Alkiswani, Morrisville, NC (US); Rohith K. Ashok, Apex, NC (US); Natasha Pothen, Raleigh, NC (US); Leigh Allen Williamson, Austin, TX (US)

Correspondence Address: CANTOR COLBURN LLP - IBM RSW, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/534,372

(22) Filed: Sep. 22, 2006

(51) Int. Cl. G06F 15/16; G06F 15/173

(52) U.S. Cl. 709/227; 709/238; 709/203

(57) ABSTRACT

A system and a method for automatically generating a proxy interface object to communicate through a gateway software server to a remote software server are provided. The method includes sending a proxy generation request message from the remote software server to the gateway software server to register a client interface object with the gateway software server and the generate a proxy interface object configured to send request messages from the gateway software server to the remote software server. The method further includes sending a proxy generation acknowledgement message from the gateway software server to the remote software server indicating the proxy interface object is functional. The method further includes sending a registration acknowledgment message from the remote software server to a customer application indicating a registration of the client interface object on the remote software server is completed.

### FIELD OF INVENTION

This application relates to a system and a method for generating a proxy interface object to communicate through a gateway software server to a remote software server.

### BACKGROUND OF THE INVENTION

Computers have been developed that communicate with a remote computer server. However, when a user's computer initially communicates with an intermediate computer server to access the remote computer server, the intermediate computer server does not have a proxy interface object to allow further communication with the remote computer server by the user's computer. Accordingly, the user's computer is not allowed to communicate through the intermediate computer server to the remote computer server.

Accordingly, the inventors herein have recognized a need for a system and a method for automatically generating proxy interface objects on an intermediate computer server.

### SUMMARY OF THE INVENTION

A method for automatically generating a proxy interface object to communicate through a gateway software server to a remote software server in accordance with an exemplary embodiment is provided. The method includes sending a proxy generation request message from the remote software server to the gateway software server to register a client interface object with the gateway software server and to generate a proxy interface object configured to send request messages from the gateway software server to the remote software server. The method further includes sending a proxy generation acknowledgement message from the gateway software server to the remote software server indicating the proxy interface object is functional. The method further includes sending a registration acknowledgement message from the remote software server to a customer application indicating a registration of the client interface object on the remote software server is completed.

A system for automatically generating a proxy interface object to communicate through a gateway software server to a remote software server in accordance with another exemplary embodiment is provided. The system includes a client computer having a client application. The system further includes a first computer server configured to communicate with the client computer. The first computer server has the remote software server. The remote software server is configured to send a proxy generation request message to the gateway software server to register a client interface object with the gateway software server and to generate a proxy interface object configured to send request message to the remote software server indicating the proxy interface object is functional. The remote software server is further configured to send a registration acknowledgement message to a customer application indicating a registration of the client interface object on the remote software server is completed.

### BRIEF DESCRIPTION OF DRAWINGS

FIG. 1 is a block diagram of a system for automatically generating a proxy interface object to communicate through a gateway software server to a remote software server in according with an exemplary embodiment; and

FIG. 2 is a flowchart of a method for automatically generating a proxy interface object to communicate through a gateway software server to a remote software server in accordance with another exemplary embodiment.

### DESCRIPTION OF AN EMBODIMENT

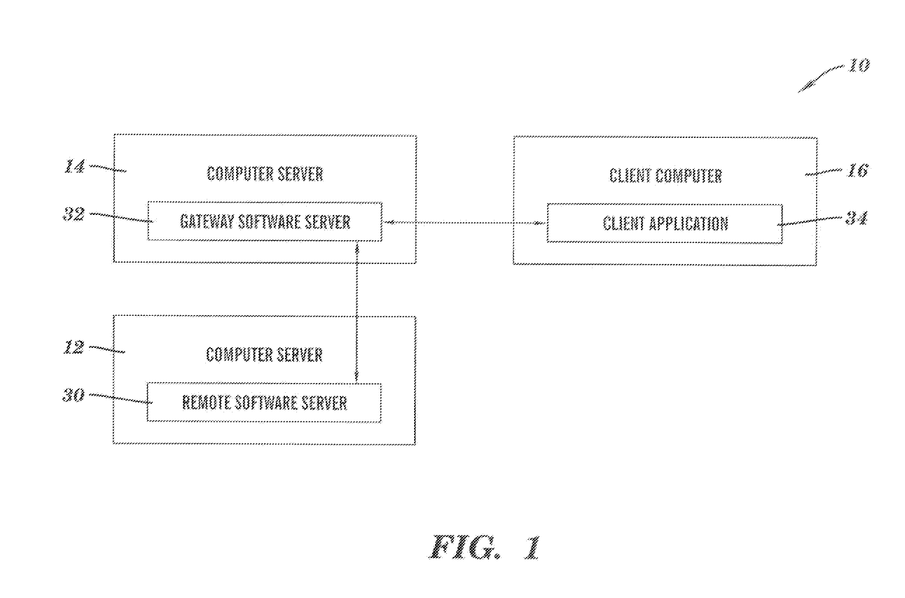

Referring to FIG. 1, a system 10 for automatically generating a proxy interface object is illustrated. The system 10 includes a computer server 12, a computer server 14, and a client computer 16. The computer server 12 has a remote software server 30 executing thereon. The computer server 14 has a gateway software server 32 executing thereon. Further, the client computer 16 has a client application 34 executing thereon. An advantage of the system 10 is that computer server 14 provides secure access to the computer server 12, such that external computers cannot access the computer server 12 directly.

The computer server 12 operably communicates with the computer server 14. In particular, the computer server 12 executes the remote software server 30 that is configured to send a proxy generation request message to the gateway software server 32 to (i) register a client interface object with the gateway software server 32, and (ii) to generate a proxy interface object configured to send request messages from the gateway software server 32 to the remote software server 30. In one exemplary embodiment, the client interface object includes metadata information associated with an MBean including for example an MBean name associated with the client computer 16, names of functions that can be invoked on the MBean, and valid parameter names and types that can be utilized by the MBean.

The computer server 14 operably communicates with both the computer server 12 and the client computer 16. The computer server 14 executes the gateway software server 32 that is configured to send a proxy generation acknowledgment message from the gateway software server 32 to the remote software server 30 indicating a proxy interface object is functional, in response to the proxy generation request message from the remote software server 30. It should be noted that in an exemplary embodiment in which the client interface object contains metadata associated with the MBean which is associated with the client computer 16, the computer server 14 stores the metadata in a local memory. The remote software server 30 of the computer server 12 is further configured to send a registration acknowledgement message to a client application 34 indicating a registration of the client interface object on the remote software server 30 is completed.

The client computer 16 operably communicates with the computer server 14. Further, the client computer 16 communicates with the computer server 12 via the computer server 14. The client computer 16 executes the client application 34 which is configured to send a connection request message to the gateway software server 32 to connect to the remote software server 30 utilizing the client interface object. In one exemplary embodiment, the connection request message contains metadata associated with an Mbean that is further associated with the client computer 16. The gateway software server 32 is configured to send the connection request message from the gateway software server 32 to be remote software server 12, in response to receiving the connection request message from the client application 34. In particular, in one exemplary embodiment, the gateway software server 32 compares the MBean data in the connection request message with locally stored MBean data associated with the client computer, and when there is correspondence between the MBean data, the gateway software server 32 sends the connection request message to the remote software server 12. Further, the remote software server 30 is configured to resend the response message to the gateway software server 32 based on the connection request message, indicating receipt of the connection request message.

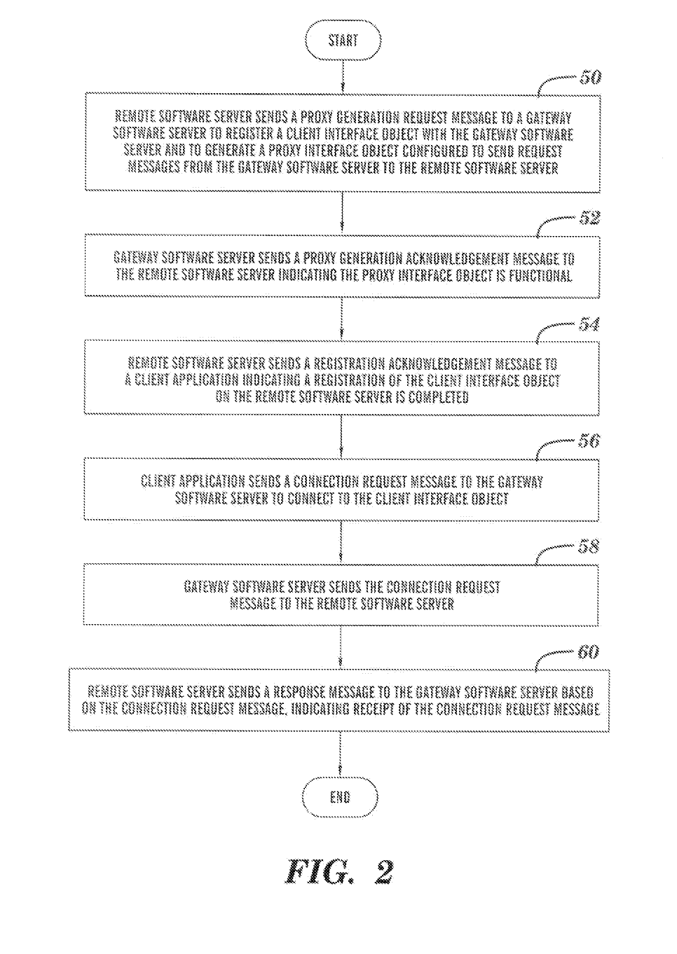

Referring to FIG. 2, a flowchart of a method for automatically generating a proxy interface object to communicate through the gateway software server 32 to the remote software server 30 will now be explained.

At step 50, the remote software server 30 sends a proxy generation request message to the gateway software server 32 to register a client interface object with the gateway software server 32 and to generate a proxy interface object configured to send request messages from the gateway software server 32 to the remote software server 30.

At step 52, the gateway software server 32 sends a proxy generation acknowledgement message to the remote software server 30 indicating the proxy interface object is functional.

At step 54, the remote software server 30 sends a registration acknowledgment message to the client application 34 indicating a registration of the client interface object on the remote software server 30 is completed.

At step 56, the client application 34 sends a connection request message to the gateway software server 32 to connect to the client interface object.

At step 58, the gateway software sever 32 sends the connection request message to the remote software server 30.

At step 60, the remote software server 30 sends a response message to the gateway software server 32 based on the connection request message, indicating receipt of the connection request message. After step 60, the method is exited.

The method for automatically generating a proxy interface object to communicate through the gateway software server 32 to the remote software sever 30 provides a substantial advantage over other methods. In particular, the method provides a technical effect of registering a client interface object associated with the client computer 16 with the gateway software sever, and further generates a proxy interface object configured to send request messages from the gateway software server 32 to the remote software server 30.

While the invention is described with reference to an exemplary embodiment, it will be understood by those skilled in the art that various changes may be made and equivalence may be substituted for elements thereof without departing from the scope of the invention. In addition, many modifications may be made to the teachings of the invention to adapt to a particular situation without departing from the scope thereof. Therefore, is intended that the invention not be limited the embodiment disclosed for carrying out this invention, but that the invention includes all embodiments falling with the scope of the intended claims. Moreover, the use of the term's first, second, etc. does not denote any order of importance, but rather the term's first, second, etc. are us are used to distinguish one element from another.

We claim:

1. A method for automatically generating a proxy interface object to communicate through a gateway software server to a remote software server, comprising:
sending a proxy generation request message from the remote software server to the gateway software server to register a client interface object with the gateway software server and to generate a proxy interface object configured to send request messages from the gateway software server to the remote software server;
sending a proxy generation acknowledgement message from the gateway software server to the remote software server indicating the proxy interface object is functional; and
sending a registration acknowledgement message from the remote software server to a customer application indicating a registration of the client interface object on the remote software server is completed.

2. The method of claim 1, further comprising:
sending a connection request message from the client application to the gateway software server to connect to the remote software server utilizing the client interface object;
sending the connection request message from the gateway software server to the remote software server; and
sending a response message from the remote software server to the gateway software server based on the connection request message, indicating receipt of the connection request message.

3. A system for automatically generating a proxy interface object to communicate through a gateway software server to a remote software server, comprising:
a client computer having a client application;
a first computer server configured to communicate with the client computer, the first computer server having the gateway software server;
A second computer server configured to communicate with the first computer server, the second computer server having the remote software server;
the remote software server configured to send a proxy generation request message to the gateway software server to register a client interface object with the gateway software server and to generate a proxy interface object configured to send request messages from the gateway software server to the remote software server;
the gateway software server configured to send a proxy generation acknowledgement message to the remote software server indicating the proxy interface object is functional; and
the remote software server further configured to send a registration acknowledgement message to a customer application indicating a registration of the client interface object on the remote software server is completed.

4. The system of claim 3, wherein the client application is configured to send a connection request message to the gateway software server to connect to the remote software server utilizing the client interface object, the gateway software server further configured to send the connection request message to the remote software server, the remote software server further configured to send a response message to the gateway software server based on the connection request message, indicating receipt of the connection request message.
